(19) United States
(12) Patent Application Publication
(10) Pub. No.: US 2021/0343055 A1
(43) Pub. Date: Nov. 4, 2021

(54) FEATURE EXTRACTION FROM DASHBOARD VISUALIZATIONS

(71) Applicant: International Business Machines Corporation, Armonk, NY (US)

(72) Inventors: GONGJIN ZHANG, Ottawa (CA); ANTHONY NICOLA TASCA, Ottawa (CA); Mohammed Mostafa, Kanata (CA); Firas Kazem, Kanata (CA)

(21) Appl. No.: 17/107,033

(22) Filed: Nov. 30, 2020

Related U.S. Application Data
(63) Continuation of application No. 63/017,766, filed on Apr. 30, 2020.

(51) Int. Cl. G06T 11/60; G06T 11/20; G06T 7/90; G06K 9/20; G06K 9/62; G06Q 10/06

(52) U.S. Cl. CPC G06T 11/60; G06T 11/206; G06T 7/90; G06K 2209/01; G06K 9/6267; G06Q 10/06393; G06K 9/2054

(57) ABSTRACT

Provided is a method for extracting features from an image of a dashboard. The method comprises detecting a position of one or more visualizations in an image of a dashboard. Each of the one or more visualizations is classified based on a type of object in the visualization. Features of the visualizations are extracted. The features include data points underlying the visualizations, one or more colors in the image, and text found in the image. An output array is generated based on the extracted features.

### BACKGROUND

The present disclosure relates generally to the field of computing, and more particularly to extracting features of a dashboard from its images.

A dashboard is a type of graphical user interface which often provides at-a-glance views of key performance indicators (KPIs) relevant to a particular objective or business process. In other usage, “dashboard” is another name for “progress report” or “report.” The “dashboard” is often displayed on a web page which is linked to a database that allows the report to be constantly updated. For example, a manufacturing dashboard may show numbers related to productivity, such as number of parts manufactured or number of failed quality inspections per hour. Similarly, a human resources dashboard may show numbers related to staff recruitment and retention.

### SUMMARY

Embodiments of the present disclosure include a method, computer program product, and system for extracting features from an image of a dashboard, including from the visualizations contained within the image. The method comprises detecting a position of one or more visualizations in an image of a dashboard. Each of the one or more visualizations is classified based on a type of object in the visualization. Features of the visualizations are extracted. The extracted features include data points underlying the visualizations, one or more colors in the image, and text found in the image. An output array is generated based on the extracted features.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 illustrates a flowchart of an example method for extracting features from a dashboard, in accordance with embodiments of the present disclosure.

FIG. 2 illustrates a flowchart of a second example method for extracting features from a dashboard, in accordance with embodiments of the present disclosure.

FIG. 3 illustrates an example dashboard in which embodiments of the present disclosure may be implemented.

FIG. 4 illustrates a visualization that has been extracted from a dashboard, in accordance with embodiments of the present disclosure.

FIG. 5 illustrates a table containing information extracted from the visualization shown in FIG. 4, in accordance with embodiments of the present disclosure.

FIG. 6 illustrates a high-level block diagram of an example computer system that may be used in implementing one or more of the methods, tools, and modules, and any related functions, described herein, in accordance with embodiments of the present disclosure.

FIG. 7 depicts a cloud computing environment, in accordance with embodiments of the present disclosure.

FIG. 8 depicts abstraction model layers, in accordance with embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the invention.

### DETAILED DESCRIPTION

Aspects of the present disclosure relate generally to the field of computing, and in particular to extracting features from an image of a dashboard, including visualizations contained within the image. While the present disclosure is not necessarily limited to such applications, various aspects of the disclosure may be appreciated through a discussion of various examples using this context.

Building a business analytics application, such as an application that provides a dashboard of KPIs for a business, can require a large amount of time and effort. Once the business analytics application is built, users may be hesitant to change the underlying architecture or platform that the application uses. One of the challenges that new customers face is migrating their existing business analytic application over to a new system, which may not be compatible with the original system. As such, the applications cannot simply be moved to the new system; they often have to be completely rebuilt. There are no migration tools for dashboards or reports that enable migration between, for example, Microsoft® Power BI®, Tableau®, or IBM Cognos® Analytics. In some cases, users also face the same dilemma if they want to migrate from older versions of a business analytics system to newer ones, or even if they want to convert from a report to a dashboard or vice versa.

Embodiments of the present disclosure provide a mechanism to enable the migration of a dashboard from one system to another, from one version of the system to another, and/or from a report to a dashboard or vice versa. Provided is a method for feature extraction for an image of a business analytic application (e.g., dashboard and/or report). The feature extraction may be performed automatically by, for example, identifying information about one or more visualizations found in the dashboard or report. The identified information may include the underlying data for each visualization in the dashboard or report (e.g., underlying data for a chart or graph), as well as the layouts, colors, and/or text used in each of the visualizations. This information may be extracted from an image (e.g., a screenshot) of a business analytics application (e.g., dashboard). In some embodiments, these features are extracted for the purpose of recreating the dashboard/report in a different business analytic tool (e.g., IBM Cognos® Analytics).

In some embodiments, the method includes the following operations: detecting the position of each visualization, classifying the type of each visualization, extracting the data points underlying the visualizations, extracting the color palette of the application, and identifying any text found in the image, including bounding boxes. These operations may be performed in various orders, with some operations performed simultaneously and others performed sequentially.

As used herein, a visualization may refer to a discrete portion of the dashboard (and, accordingly, a portion of the image) that contains or depicts a visual object, such as a chart, a graph, a table, etc. Accordingly, an image of a dashboard may contain multiple visualizations; one corresponding to each object in the dashboard. For example, a dashboard may include two different graphs. As such, an image of this dashboard can be said to include two visualizations, one corresponding to each graph. Embodiments of the present disclosure can be applied to dashboards having any number of objects and corresponding visualizations.

Because a visualization is a portion of the dashboard (or a portion of an image of the dashboard) that contains or depicts a visual object, the terms visualization and object are used in similar manners and/or interchangeably herein, except where it is clear from the context that they are describing different things. For example, “classifying the type of a visualization” and “classifying a type of an object” may refer to the same concept, namely determining the type of information (e.g., line graph, bar graph, pie chart, etc.) displayed in a given portion of the dashboard (e.g., depicted by the visualization). So if, for example, the visualization is of a pie chart, the “type” of the visualization and the “type” of the object are the same thing; namely, a pie chart. Similarly, if the visualization is of a line graph, “extracting the data points underlying the visualizations” may include determining the values of the data points of the object depicted in the visualization (e.g., in the line graph), and may accordingly be referred to as extracting the data points of the object.

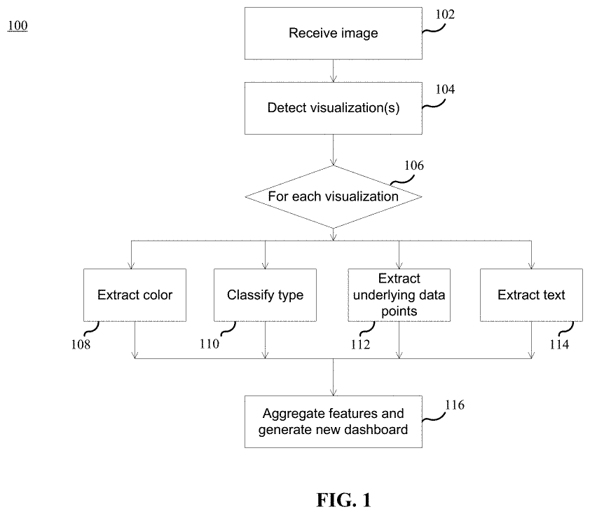

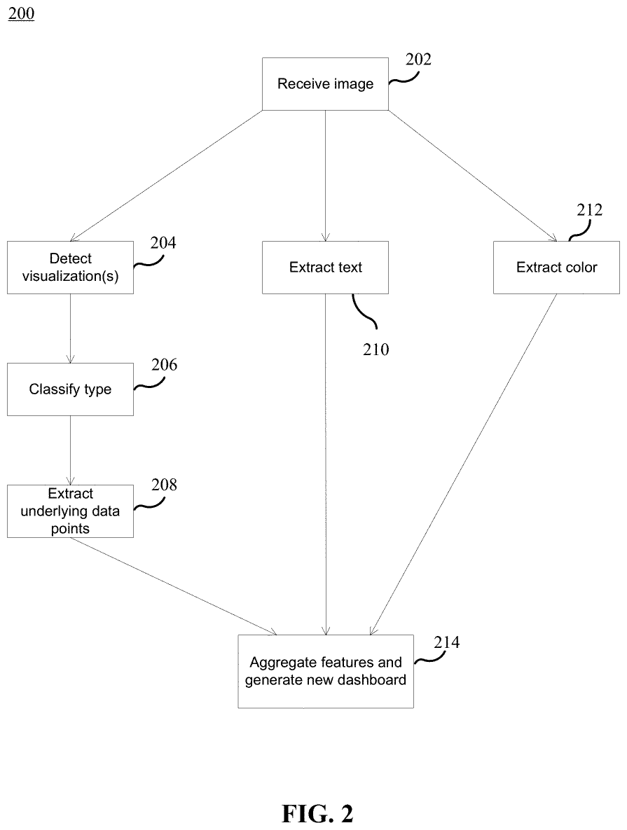

Two example methods will now be discussed with reference to FIGS. 1 and 2, according to embodiments of the present disclosure. Referring first to FIG. 1, illustrated is a flowchart of an example method 100 for extracting features from an image of a dashboard, in accordance with embodiments of the present disclosure. The method 100 may be performed by hardware, firmware, software executing on a processor, or any combination thereof. The method 100 may begin at operation 102, wherein an input image is received. In at least one embodiment of the present disclosure, the received image is an image of a dashboard, report, or other business analytic application that is input by a user.

For example, at operation 102, the user may input one or more images into a system for extracting features of a dashboard for migrating a dashboard from one business analytic environment to another. Each image may be, for example, a screenshot of a dashboard or report, and can have any suitable format (e.g., .jpeg, .png, .jpg, .gif, .tiff, etc.). Each image may relate to a different view of the dashboard. For example, a dashboard may include one or more tabs that, when selected, switch to a different “page” of the dashboard. Each image may pertain to one of such tabs. A user may click through the various tabs or other page-changing elements and create an image for each “page.”

In some embodiments, the system may be configured to generate the one or more images itself. For example, the user could select a dashboard that is going to be migrated, and the system may generate a plurality of images for the dashboard (e.g., one image for each view of the dashboard). In at least one embodiment of the present disclosure, the system could generate the plurality of images by identifying clickable elements (e.g., tabs for different pages, etc.) in the dashboard that change the view of the dashboard and then selecting each element to flip through the various views (e.g., the tabs). In embodiments where the user (or the system) selects, generates, or otherwise inputs multiple images, operations 104-116 may be performed for each image.

At operation 104, the system uses a custom object detection model to detect one or more visualizations (e.g., depicting objects such as charts, tables, graphs) in the image. In at least one embodiment of the present disclosure, detecting the one or more visualizations includes detecting a location of each visualization in the image. The term “location” and the term “position” are used interchangeably herein. The object detection model may be trained specifically to detect objects (e.g., charts, graphs) in dashboards and business analytics reports using image/object analysis and recognition. The various objects are detected based on analysis of the dashboard image. The customized object detection model may be based on a convolutional neural network that is trained to differentiate between various visualizations/objects in the image and detect their locations.

Accordingly, at operation 104, the object detection model is applied to process each input image of a business analytic application (dashboard or report) and detect the location of each visualization in the application. In some embodiments, this customized detection model can be created using the Watson® Visual Recognition Service. The customized object detection model is trained on a dataset consisting of images of dashboards and/or reports. All of the types of visualizations in the dataset are labeled with the same detection class. Accordingly, the custom object detection model is trained to detect every visualization, but it does not need to differentiate between types of visualizations (e.g., bar chart vs. line graph). This novel training method reduces the learning difficulty of the object detection model without the need to modify the model itself. Therefore, the performance of the model is improved compared to training the model with one class per visualization type. The output from the object detection model is the identification of the objects (and associated visualizations) and their relative locations on the dashboard.

At operation 106, each visualization (e.g., for each detected object) is “cut” out of the image and separated for individualized analysis. For example, after visualizations have been detected at operation 104, they are cut out of the input image using the detected locations. In at least one embodiment of the present disclosure, locations are detected using bounding boxes that define the edges of the visualization. Each extracted, or cut out, visualization can then be treated individually as a separate image. The individual visualizations are then processed to extract feature information from them. Feature information may include, by way of non-limiting example, color, type, underlying data, and/or text. Each visualization may be processed at one or more of operations 108-114, which may be performed partially or wholly simultaneously, partially or wholly sequentially, and/or in various orders.

At operation 108, the system uses a color extraction method to extract one or more dominant colors present in the visualization. Any color extraction model that is able to detect the dominant colors used in an image may be applied to the image of the dashboard/report to extract one or more dominant colors present in the visualization. The dominant colors extracted from the image can then be used to create a color palette for the migrated or new dashboard. Accordingly, by extracting the dominant colors from the image to create the color palette, the migrated or new dashboard can be made to look like the original dashboard depicted in the image that the user input at operation 102.

In some embodiments, the color palette extraction process can be applied to each visualization individually, to two or more visualizations as a set, on the dashboard/image level, or any combination thereof. In other words, the system may determine the dominant colors for the dashboard as a whole, for a subset of the visualizations, for each visualization separately, or any combination thereof. In order to perform visualization-level analysis, the color extraction model may use the location data determined at operation 104 to analyze each visualization separately. Extracting out color palettes at multiple granularity levels enables the user to be provided more options when generating the migrated or new dashboard. In such embodiments, the user is then able to select a color palette that he or she prefers.

At operation 110, the system uses one or more custom object classification models to classify the type of object represented by the visualization. In these embodiments, the visualizations may be fed into a custom image classification model based on a convolutional neural network (e.g., that performs object classification). In some embodiments, this custom classification model can be created using the Watson® Visual Recognition Service. The model classifies each visualization as one of the pre-defined types such as bar chart, pie chart, line chart, etc. The custom image classification model is trained with a dataset consisting of images of individual visualizations having a variety of known types.

At operation 112, the system extracts the underlying data points and other information from the visualization. The extracted data may include values for various parameters, as well as names of those parameters (e.g., column names). The extracted data points could be stored in a table or other array. In some embodiments, the data point extraction tool can be any tool that is able to analyze the visualization and then generate a data table from the visualization.

In some embodiments, the system may select from a plurality of data point extraction tools or models. For example, the system may include a plurality of models for extracting data points from different types of visualizations. Using the output from operation 110 (i.e., the type of visualization), the system may select an appropriate model to use when extracting out the data values. This may be done, for example, based on the accuracy or efficiency of the models at extracting data from certain types of visualizations. For example, the system may use a first model to extract information from pie charts and a second model to extract information from bar graphs. This may be done due to the computational efficiency and/or accuracy of the models (e.g., the first model is better at extracting data from pie charts than the second model, but the second model is better than the first at extracting data from bar graphs). Any number of suitable models may be used, and their selection may be based on system resources, efficiency of the models, accuracy of the models, other factors recognized by persons of ordinary skill in the arts, or any combination thereof.

At operation 114, the system uses optical character recognition to extract text from the visualization and/or the image. In at least one embodiment of the present disclosure, extracting text includes detecting the location and value of text in the visualization and/or the image. In at least one embodiment of the present disclosure, the system may utilize an Optical Character Recognition (OCR) model (e.g., the tesseract library) to extract the text. In at least one embodiment, the text is extracted from the image of a dashboard/report. This can include text that is in a visualization. In at least one embodiment, the text is extracted from an individual visualization. In such embodiments, the model identifies the text and the position of the text in the visualization. Extracted text may include, but is not restricted to: the dashboard/report title, the titles of individual tabs, the title and axis labels of each visualization, and any text widget content.

In some embodiments, the OCR model detects the text and its bounding box (its position, e.g., pixel location), as well as additional information about the text. The additional information may include, but is not limited to, one or more of: its height (e.g., Y pixels tall); its width (e.g., X pixels wide); its directionality/orientation, such as whether the text is displayed normally in a left-to-right fashion, whether it is displayed vertically (e.g., rotated 90°), or whether it is rotated by some other amount (e.g., 45°); and/or its color.

At operation 116, the system aggregates the feature information extracted from each visualization and from each extraction operation (e.g., operations 108-114) applied to each visualization. The system uses the aggregated feature information to generate a logically grouped specification (e.g., in the form of an array). The logically grouped specification includes information about the visualizations that enables the system (or other systems) to generate a comparable, representative visualization. In other words, the feature information that was extracted and determined for the visualizations enables the generation of a new dashboard, in the same or different business analytics platform, that contains the same information and/or user experience (UX), or feel, as the original dashboard. This allows for the effective migration of the dashboard from one system to another.

Referring now to FIG. 2, illustrated is a flowchart of a second example method 200 for extracting features or feature information from a dashboard, in accordance with embodiments of the present disclosure. The method 200 may be performed by hardware, firmware, software executing on a processor, or any combination thereof. The method 200 may include the same operations as the method 100, just arranged in a different order. As such, details about the individual operations are omitted for brevity.

In the method 200, an image is received at operation 202. For example, at operation 202, a user may upload an image of a dashboard. This may be done in substantially the same way as described with respect to operation 102 of method 100 (shown in FIG. 1).

The visualizations, including the location of each visualization, in the image may be detected at operation 204. This may be done in substantially the same way as described with respect to operation 104 of method 100.

The system may then classify the visualizations at operation 206. The classification may indicate the type of object depicted in the visualizations (e.g., bar graph, pie chart, etc.) This may be done in substantially the same way as described with respect to operation 110 of method 100. At this point, the system has information pertaining to a set of visualizations, a location of each visualization, and a type of each visualization.

The system may then extract data points from each visualization at operation 208. This may be done in substantially the same way as described with respect to operation 112 of method 100.

At substantially the same time that one or more of operations 204-208 are being performed, the system may extract text from the image at operation 210. This may be done in substantially the same way as described with respect to operation 114 of method 100.

At substantially the same time that one or more of operations 204-208 and/or operation 210 are being performed, the system may extract dominant colors from the image and generate a color palette of the dominant colors at operation 212. This may be done in substantially the same way as described with respect to operation 108 of method 100.

The outputs from each of operations 208, 210, and 212 (i.e., various features of the image) may be aggregated at operation 214. This may be done in substantially the same way as described with respect to operation 116 of method 100.

In some embodiments, the system may be configured to effectively perform one or more of five discrete operations:

1. Detect the locations of visualizations in a business analytic application

2. Classify the visualizations into chart types

3. Extract text from the images and/or visualizations

4. Extract one or more color palettes from the images and/or visualizations

5. Extract data points from the visualizations.

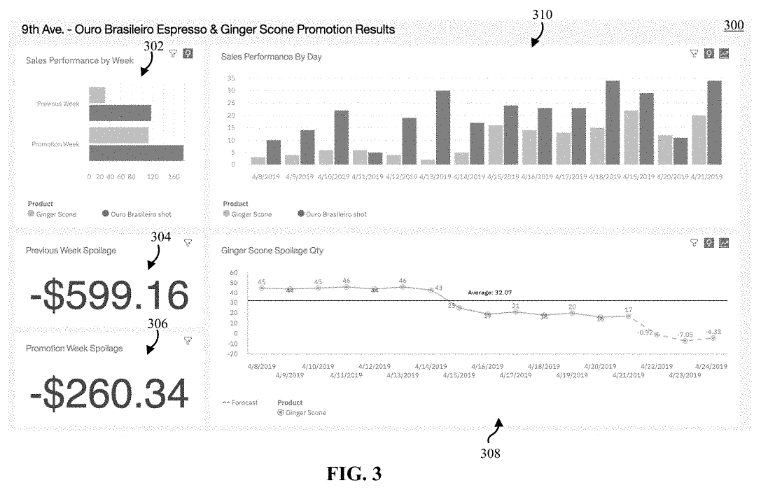

An example application of one or more embodiments of the present disclosure will now be described with reference to FIGS. 3-5. Looking first at FIG. 3, illustrated is an example dashboard 300 in which embodiments of the present disclosure may be implemented.

The dashboard 300 is a dashboard showing sales data for an Ouro Brasileiro espresso and ginger scone promotion. The dashboard includes five discrete objects. The first object 302 displays sales performance by week using a bar graph. The second object 304 displays the monetary value of the spoilage the week before the promotion. The third object 306 displays the monetary value of the spoilage during the promotion week. The fourth object 308 displays the ginger scone spoilage quantity over the course of 16 days using a line graph. The fifth object 310 displays the sales performance by day using a bar graph. Each of the five objects is associated with its own visualization.

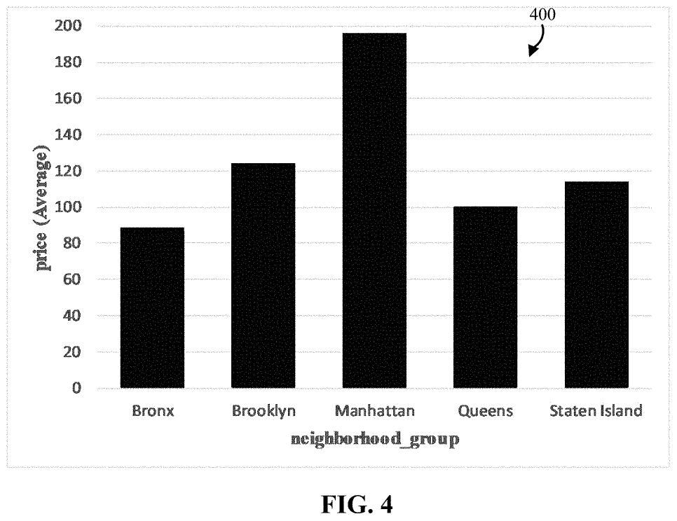

A user of the disclosed system takes an image of the dashboard 300 and feeds it into the system. This is an example of the performance of operation 102 of method 100. The system then uses a custom object detection model to automatically detect the five objects 302-310 (and the five corresponding visualizations) in the dashboard 300. This is an example of the performance of operation 104 of method 100. The system then “cuts” out each visualization and performs feature extraction processes on each visualization. An example of a visualization that could be cut out is shown in FIG. 4.

Referring now to FIG. 4, illustrated is a visualization 400 that has been extracted from a dashboard, in accordance with embodiments of the present disclosure. The visualization 400 is a bar chart representing the average price of some good or service in the five boroughs of New York City. After the visualization 400 is cut out of the larger image, it can be processed such that various features are extracted from it. This processing may include one or more of the operations 108-114 described with respect to FIG. 1.

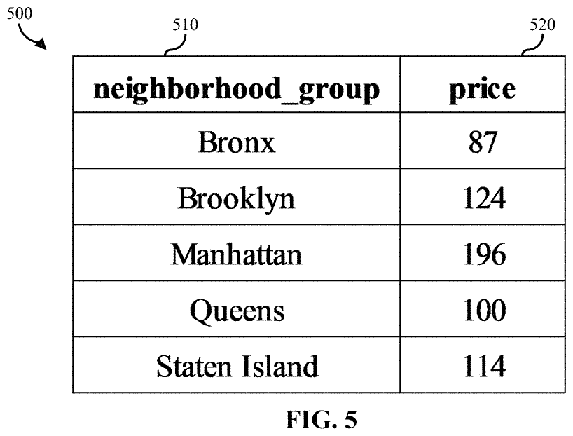

For example, as shown in FIG. 5, the system may extract chart data points from the visualization 400. This may be done as described with respect to operation 112. In the example shown in FIGS. 4 and 5, the system analyzes the visualization 400 and extracts out the text (e.g., Bronx, Brooklyn, etc.) and corresponding values. The text and values may then be correlated into an array, table, or other data storage form 500. For example, as shown in the first column 510 of the table 500, the system has determined that the X-axis represents the “neighborhood group” and includes Bronx, Brooklyn, Manhattan, Queens, and Staten Island. Similarly, the system has determined that the Y-axis represents the price, as shown in the second column 520 of the table 500. The system has further analyzed the visualization 400 to determine the value for each borough based on the size of the associated bars in the visualization 400. For example, the system has determined that the price of the good or service averages $87 in the Bronx, $124 in Brooklyn, $196 in Manhattan, $100 in Queens, and $114 in Staten Island based on image analysis of the visualization 400.

While not shown in the figures, the system may also extract additional features about the visualization 400, such as the color (operation 108). Once all of the relevant features have been extracted, the system may aggregate the features and generate an array or other output (e.g., a specification) that includes the features in a logically ordered way. This output may then be used to generate a new dashboard in a different system, where the new dashboard is substantially similar to the original dashboard.

The following is an example of the output array of this dashboard feature extraction as applied to the visualization 400:

{

“widgets”: [

{

“type”: “Column”,
“layout”: {

“left”: “15px”,
“top”: “15px”,
“height”: “45px”,
“width”: “45px”

},
“data”: [

{

“name”: “Bronx”,
“value”: “87”

},{

“name”: “Brooklyn”,
“value”: “124”

},{

“name”: “Manhattan”,
“value”: “196”

},{

“name”: “Queens”,
“value”: “100”

},{

“name”: “Staten Island”,
“value”: “114”

}

],
“text”: [

{

“value”: “neighborhood_group”,
“layout”: {

“left”: “300px”,
“top”: “610px”,
“height”: “8px”,
“width”: “104px”

}

}, {

“value”: “price (Average)”,
“layout”: {...}

}, {

“value”: “Bronx”,
“layout”: {...}

}, {

“value”: “Brooklyn”,
“layout”: {...}

}, {

“value”: “Manhattan”,
“layout”: {...}

}, {

“value”: “Queens”,
“layout”: {...}

}, {

“value”: “Staten Island”,
“layout”: {...}

}, {

“value”: “200”,
“layout”: {...}

}, {

“value”: “180”,
“layout”: {...}

}, {

“value”: “160”,
“layout”: {...}

}, {

“value”: “140”,
“layout”: {...}

}, {

“value”: “120”,
“layout”: {...}

}, {

“value”: “100”,
“layout”: {...}

}, {

“value”: “80”,
“layout”: {...}

}, {

“value”: “60”,
“layout”: {...}

}, {

“value”: “40”,
“layout”: {...}

}, {

“value”: “20”,
“layout”: {...}

}, {

“value”: “0”,
“layout”: {...}

}

],
“colors”: [“#44a5d8”]

}

]

}

As can be seen from this output array, the type of chart (column) and values for each of the boroughs, as well as the borough names, are included. Similarly, the minor and major gridlines (which are shown every $20 increase in price) are also included in the output array. Furthermore, information such as the size of the font, the color of the visualization 400, and the axis titles are included. This information allows a system to rebuild the dashboard without tedious, manual work.

Each object in the dashboard may have its own “widget” in the output array. For example, while the above output array includes information for the visualization 400 in FIG. 4, other visualizations in the dashboard (not shown) would have their features extracted as well. As such, the output array would also include the information for each of those other visualizations. For example, the output array of this dashboard feature extraction as applied to a pie chart type visualization from the same image (not shown) may also include the following:

{

“widgets”: [

{

“type”: “Pie”,
“layout”: {...},
“data”: [...],
“text”: [...],
“colors”: [...]

},

as well as the pertinent data.

In this way, each input dashboard may have a single output array that includes the features of every visualization found in that dashboard. In some embodiments, a single dashboard may have multiple output arrays (e.g., one for each “view” or “page,” one for each visualization, etc.).

In some embodiments, the system uses the output array to generate a new dashboard. In some embodiments, the system exports the generated output array (e.g., to another application on the system, to another system, etc.) for generating the new dashboard. For example, the system may be a cloud-based system that is configured to export the output array to another system in the cloud which hosts the dashboard.

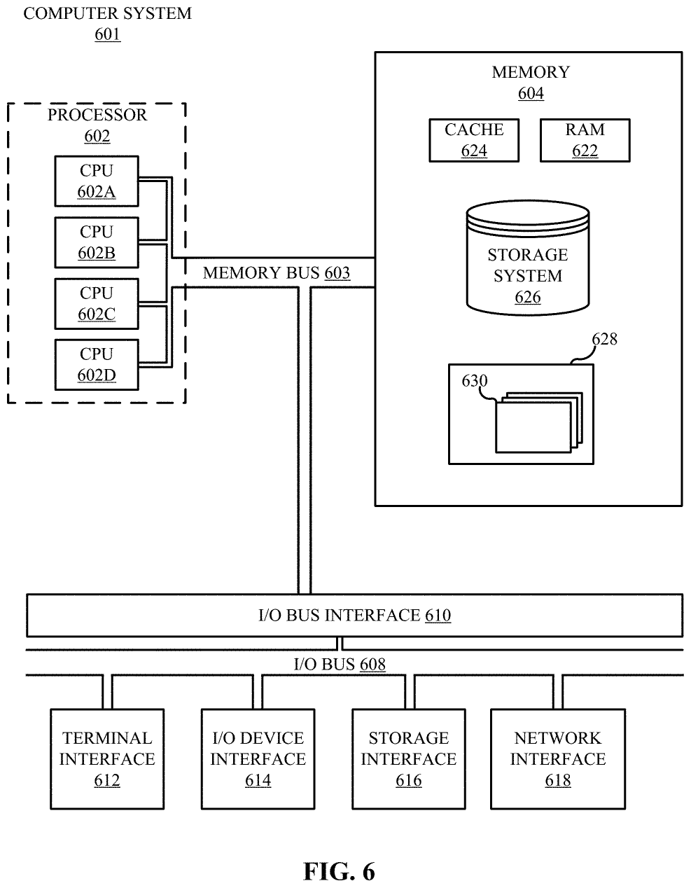

Referring now to FIG. 6, shown is a high-level block diagram of an example computer system 601 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 601 may comprise one or more CPUs 602, a memory subsystem 604, a terminal interface 612, a storage interface 616, an I/O (Input/Output) device interface 614, and a network interface 618, all of which may be communicatively coupled, directly or indirectly, for inter-component communication via a memory bus 603, an I/O bus 608, and an I/O bus interface unit 610.

The computer system 601 may contain one or more general-purpose programmable central processing units (CPUs) 602A, 602B, 602C, and 602D, herein generically referred to as the CPU 602. In some embodiments, the computer system 601 may contain multiple processors typical of a relatively large system; however, in other embodiments the computer system 601 may alternatively be a single CPU system. Each CPU 602 may execute instructions stored in the memory subsystem 604 and may include one or more levels of on-board cache.

System memory 604 may include computer system readable media in the form of volatile memory, such as random access memory (RAM) 622 or cache memory 624. Computer system 601 may further include other removable/non-removable, volatile/non-volatile computer system storage media. By way of example only, storage system 626 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 604 can include flash memory, e.g., a flash memory stick drive or a flash drive. Memory devices can be connected to memory bus 603 by one or more data media interfaces. The memory 604 may include at least one program product having a set (e.g., at least one) of program modules that are configured to carry out the functions of various embodiments.

One or more programs/utilities 628, each having at least one set of program modules 630 may be stored in memory 604. The programs/utilities 628 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Program modules 630 generally perform the functions or methodologies of various embodiments.

Although the memory bus 603 is shown in FIG. 6 as a single bus structure providing a direct communication path among the CPUs 602, the memory subsystem 604, and the I/O bus interface 610, the memory bus 603 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 610 and the I/O bus 608 are shown as single respective units, the computer system 601 may, in some embodiments, contain multiple I/O bus interface units 610, multiple I/O buses 608, or both. Further, while multiple I/O interface units are shown, which separate the I/O bus 608 from various communications paths running to the various I/O devices, in other embodiments some or all of the I/O devices may be connected directly to one or more system I/O buses.

In some embodiments, the computer system 601 may be a multi-user mainframe computer system, a single-user system, or a server computer or similar device that has little or no direct user interface, but receives requests from other computer systems (clients). Further, in some embodiments, the computer system 601 may be implemented as a desktop computer, portable computer, laptop or notebook computer, tablet computer, pocket computer, telephone, smart phone, network switches or routers, or any other appropriate type of electronic device.

It is noted that FIG. 6 is intended to depict the representative major components of an exemplary computer system 601. In some embodiments, however, individual components may have greater or lesser complexity than as represented in FIG. 6, components other than or in addition to those shown in FIG. 6 may be present, and the number, type, and configuration of such components may vary. Furthermore, the modules are listed and described illustratively according to an embodiment and are not meant to indicate necessity of a particular module or exclusivity of other potential modules (or functions/purposes as applied to a specific module).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

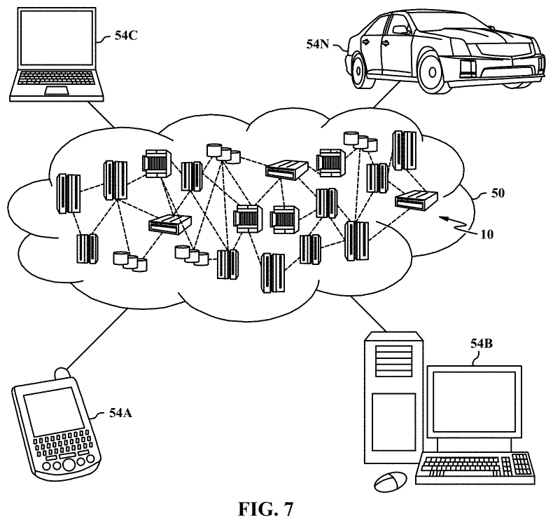

Referring now to FIG. 7, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

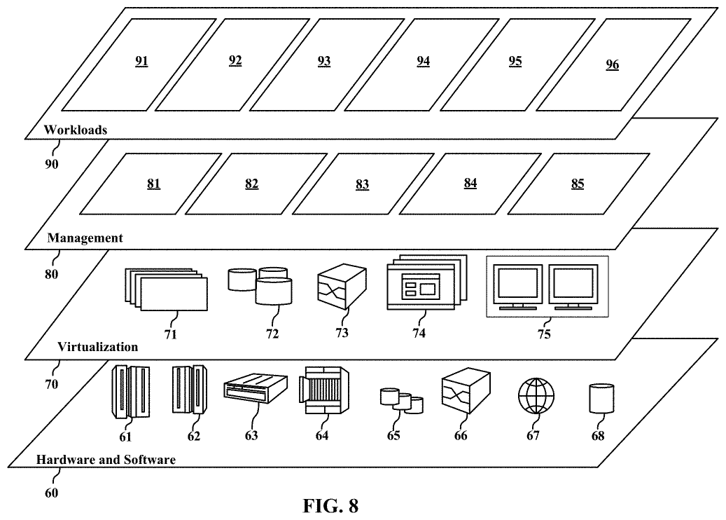

Referring now to FIG. 8, a set of functional abstraction layers provided by cloud computing environment 50 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and dashboard generation 96.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that the aforementioned advantages are example advantages and should not be construed as limiting. Embodiments of the present disclosure can contain all, some, or none of the aforementioned advantages while remaining within the spirit and scope of the present disclosure.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments may be practiced. These embodiments were described in sufficient detail to enable those skilled in the art to practice the embodiments, but other embodiments may be used and logical, mechanical, electrical, and other changes may be made without departing from the scope of the various embodiments. In the previous description, numerous specific details were set forth to provide a thorough understanding the various embodiments. But, the various embodiments may be practiced without these specific details. In other instances, well-known circuits, structures, and techniques have not been shown in detail in order not to obscure embodiments.

As used herein, “a number of” when used with reference to items, means one or more items. For example, “a number of different types of networks” is one or more different types of networks.

When different reference numbers comprise a common number followed by differing letters (e.g., 100a, 100b, 100c) or punctuation followed by differing numbers (e.g., 100-1, 100-2, or 100.1, 100.2), use of the reference character only without the letter or following numbers (e.g., 100) may refer to the group of elements as a whole, any subset of the group, or an example specimen of the group.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the foregoing, reference is made to various embodiments. It should be understood, however, that this disclosure is not limited to the specifically described embodiments. Instead, any combination of the described features and elements, whether related to different embodiments or not, is contemplated to implement and practice this disclosure. Many modifications, alterations, and variations may be apparent to those of ordinary skill in the art without departing from the scope and spirit of the described embodiments. Furthermore, although embodiments of this disclosure may achieve advantages over other possible solutions or over the prior art, whether or not a particular advantage is achieved by a given embodiment is not limiting of this disclosure. Thus, the described aspects, features, embodiments, and advantages are merely illustrative and are not considered elements or limitations of the appended claims except where explicitly recited in a claim(s). Additionally, it is intended that the following claim(s) be interpreted as covering all such alterations and modifications as fall within the true spirit and scope of the invention.

What is claimed is:

1. A method comprising:
detecting a position of one or more visualizations in an image of a dashboard;
classifying each of the one or more visualizations based on a type of object depicted in the visualization;
extracting features of the visualization, wherein the features include data points underlying the visualization, one or more colors in the image, and text found in the image; and
generating, based on the extracted features, an output array.

2. The method of claim 1, wherein the type of object includes one or more selected from the group consisting of charts, tables, bar graphs, pie charts, and line graphs.

3. The method of claim 1, wherein detecting the position of the one or more visualizations includes performing image analysis on the image using an object detection model trained to detect locations of charts, tables, and graphs in the image.

4. The method of claim 1, wherein extracting the data points includes:
identifying a plurality of data point extraction models, each data point extraction model being associated with one or more types of objects;
determining, based on the type of object included in each visualization, which data point extraction model to use for each visualization; and
feeding the image of each respective visualization into its respective data point extraction model.

5. The method of claim 1, the method further comprising:
extracting each of the one or more visualizations into its own image.

6. The method of claim 1, wherein extracting the one or more colors comprises:
extracting one or more dominant colors from each object in the image at the object level; and
extracting one or more dominant colors from the image at the image level.

7. The method of claim 1, wherein extracting the text comprises:
performing optical character recognition to identify text in the visualization and convert it into machine-encoded text; and
detecting positions of the text in the visualization.

8. A system comprising:
a memory; and
a processor communicatively coupled to the memory, wherein the processor is configured to perform a method comprising:
detecting a position of one or more visualizations in an image of a dashboard;
classifying each of the one or more visualizations based on a type of object depicted in the visualization;
extracting features of the visualization, wherein the features include data points underlying the visualization, one or more colors in the image, and text found in the image; and
generating, based on the extracted features, an output array.

9. The system of claim 8, wherein the type of object includes one or more selected from the group consisting of charts, tables, bar graphs, pie charts, and line graphs.

10. The system of claim 8, wherein detecting the position of the one or more visualizations includes performing image analysis on the image using an object detection model trained to detect locations of charts, tables, and graphs in the image.

11. The system of claim 8, wherein extracting the data points includes:
identifying a plurality of data point extraction models, each data point extraction model being associated with one or more types of objects;
determining, based on the type of object included in each visualization, which data point extraction model to use for each visualization; and
feeding the image of each respective visualization into its respective data point extraction model.

12. The system of claim 8, wherein the method further comprises:
extracting each of the one or more visualizations into its own image.

13. The system of claim 8, wherein extracting the one or more colors comprises:
extracting one or more dominant colors from each object in the image at the object level; and
extracting one or more dominant colors from the image at the image level.

14. The system of claim 8, wherein extracting the text comprises:
performing optical character recognition to identify text in the visualization and convert it into machine-encoded text; and
detecting positions of the text in the visualization.

15. A computer program product comprising a computer readable storage medium having program instructions embodied therewith, the program instructions executable by a computer to perform a method comprising:
detecting a position of one or more visualizations in an image of a dashboard;
classifying each of the one or more visualizations based on a type of object depicted in the visualization;
extracting features of the visualization, wherein the features include data points underlying the visualization, one or more colors in the image, and text found in the image; and
generating, based on the extracted features, an output array.

16. The computer program product of claim 15, wherein the type of object includes one or more selected from the group consisting of charts, tables, bar graphs, pie charts, and line graphs.

17. The computer program product of claim 15, wherein detecting the position of the one or more visualizations includes performing image analysis on the image using an object detection model trained to detect locations of charts, tables, and graphs in the image.

18. The computer program product of claim 15, wherein extracting the data points includes:
identifying a plurality of data point extraction models, each data point extraction model being associated with one or more types of objects;
determining, based on the type of object included in each visualization, which data point extraction model to use for each visualization; and
feeding the image of each respective visualization into its respective data point extraction model.

19. The computer program product of claim 15, wherein extracting the one or more colors comprises:
extracting one or more dominant colors from each object in the image at the object level; and
extracting one or more dominant colors from the image at the image level.

20. The computer program product of claim 15, wherein extracting the text comprises:
performing optical character recognition to identify text in the visualization and convert it into machine-encoded text; and
detecting positions of the text in the visualization.
